(19) United States
(12) Patent Application Publication
(10) Pub. No.: US 2010/0236961 A1
(43) Pub. Date: Sep. 23, 2010

(54) DEMONSTRATIVE METHODS FOR PAPER TOWEL PRODUCTS

(76) Inventors: Ann Marie WOULMS, Milan, IN (US); Kevin Mitchell WIWI, West Chester, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/725,734

(22) Filed: Mar. 17, 2010

Related U.S. Application Data
(60) Provisional application No. 61/258,372, filed on Nov. 5, 2009.
(60) Provisional application No. 61/160,840, filed on Mar. 17, 2009.

(51) Int. Cl. B65D 85/00; G09B 25/00

(52) U.S. Cl. 206/459.5; 434/365

(57) ABSTRACT

Demonstrative methods for test substrates such as paper towel products, and more particularly, methods for demonstrating surface cleaning performance of the test substrate product or performance differences between two or more test substrates, are provided. Further, paper towel product packages and marketing articles that evidence surface cleaning performance of a test substrate and/or performance differences between test substrates, are also provided.

### CROSS REFERENCE TO RELATED APPLICATIONS

This application claims the benefit of U.S. Provisional Application No. 60/258,372 filed on Nov. 5, 2009, and the benefit of U.S. Provisional Application No. 61/160,840 filed on Mar. 17, 2009.

### FIELD OF THE INVENTION

The present invention relates to methods for demonstrating surface cleaning performance or performance differences between two or more test substrates such as paper towel products or cleaning implements and presenting the results to the consumer, e.g. evidencing the surface cleaning performance or performance differences to the consumer.

### BACKGROUND OF THE INVENTION

Consumers of paper towel products continue to demand improved performance in their paper towel products. As a result, formulators are continually trying to improve upon paper towel product properties that are desired by consumers. However, formulators are faced with trying to communicate to the consumers, especially in a meaningful, clear and visual manner, that their paper towel product demonstrates improved cleaning performance, for example, compared to other paper towel products.

Accordingly, there is a need for a method for demonstrating to a consumer, surface cleaning performance of a paper towel product. Also there is a need for a method to demonstrate performance differences between test substrates such as paper towel products and/or cleaning implements, and clearly communicating these differences to the consumer.

### SUMMARY OF THE INVENTION

The present invention fulfills the needs described above by providing a method for demonstrating, surface cleaning performance of paper products or performance differences between two or more test substrates. Furthermore, the present invention provides paper product packages and marketing articles that evidence surface cleaning performance of paper products or performance differences of two or more test substrates.

In one example the present invention provides a method for demonstrating, e.g. to a consumer, surface cleaning performance of a paper product comprising the steps of:

selecting at least one test substrate;

selecting at least one demonstration implement for at least one test substrate;

selecting a testing surface;

preparing at least one spill specimen for at least one test substrate;

applying each spill specimen to the testing surface; in an embodiment applying each spill specimen to a different area of the testing surface;

wiping the spill specimen on the testing surface with the test substrate wherein at least some of the spill specimen adheres to the test substrate and some of the spill specimen remains on the testing surface as residual spill specimen, and thereafter, wiping the residual spill specimen left on the testing surface with a demonstration implement wherein at least some of the residual spill specimen adheres to the demonstration implement;

demonstrating the surface cleaning performance of the test substrate.

optionally presenting the results to the consumer.

In another example the present invention provides a paper towel product package comprising a paper towel product and a packaging comprising a textual or non-textual indicia that evidences to a consumer that the test substrate, such as a paper towel product exhibits, via the method herein, surface cleaning performance of the test substrate or performance differences between two or more test substrates.

In yet another example the present invention provides a marketing article comprising a textual or non-textual indicia that evidences to a consumer the performance of a test substrate, via the method herein, surface cleaning performance of the test substrate or performance differences of two or more test substrates.

Accordingly, the present invention provides a method for demonstrating to a consumer surface cleaning performance of a test substrate or performance differences between two or more test substrates. This invention further provides paper towel product packages and marketing articles that evidence surface cleaning performance of a test substrate or performance differences of two or more test substrates.

### BRIEF DESCRIPTION OF THE DRAWINGS

FIG. 1 is a schematic representation of an example of a method for demonstrating to a consumer, the surface cleaning performance of a test substrate or for performance differences between two or more test substrates, according to the present invention; and

FIG. 2 is a schematic representation of a hand holding a paper towel product according to the present method.

FIG. 3 is a front view of an example of a test substrate package such as a paper towel product package according to the present invention;

FIG. 4 is a front view of an example marketing article according to the present invention.

FIG. 5 is a photograph of the wiping step with the demonstration implement.

### DETAILED DESCRIPTION OF THE INVENTION

### Definitions

“Fiber” as used herein means an elongate particulate having an apparent length greatly exceeding its apparent diameter, i.e. a length to diameter ratio of at least about 10. Fibers having a non-circular cross-section are common; the “diameter” in this case may be considered to be the diameter of a circle having cross-sectional area equal to the cross-sectional area of the fiber. More specifically, as used herein, “fiber” refers to fibrous structure-making fibers. The present invention contemplates the use of a variety of fibrous structure-making fibers, such as, for example, natural fibers, including wood fibers, or synthetic fibers made from natural polymers and/or synthetic fibers, or any other suitable fibers, and any combination thereof.

As used herein, “fibrous structure products” or “paper products” or “products” mean paper products comprising fibrous structure, usually cellulose fibers. In one embodiment, the products of the present invention include tissue-towel paper products, including paper toweling, facial tissue, bath tissue, table napkins, and the like. “Paper towels” and “paper towel products” as used herein include napkin products. The products of the present invention may be in any suitable form, such as in a roll, in individual sheets, in connected, but perforated sheets, in a folded format or even in an unfolded format.

“Fibrous structure” as used herein means a structure (web) that comprises one or more fibers. Nonlimiting examples of processes for making fibrous structures include known wet-laid fibrous structure making processes, air-laid fibrous structure making processes, meltblowing fibrous structure making processes, co-forming fibrous structure making processes, and spunbond fibrous structure making processes. Such processes typically include steps of preparing a fiber composition, oftentimes referred to as a fiber slurry in wet-laid processes, either wet or dry, and then depositing a plurality of fibers onto a forming wire or belt such that an embryonic fibrous structure is formed, drying and/or bonding the fibers together such that a fibrous structure is formed, and/or further processing the fibrous structure such that a finished fibrous structure is formed. The fibrous structure may be a through-air-dried fibrous structure and/or conventionally dried fibrous structure. The fibrous structure may be creped or uncreped. The fibrous structure may exhibit differential density regions or may be substantially uniform in density. The fibrous structure may be pattern densified, conventionally felt-presses and/or high-bulk, uncompacted. The fibrous structures may be homogenous or multilayered in construction.

After and/or concurrently with the forming of the fibrous structure, the fibrous structure may be subjected to physical transformation operations such as embossing, calendaring, selfing, printing, folding, softening, ring-rolling, applying additives, such as latex, lotion and softening agents, combining with one or more other plies of fibrous structures, and the like to produce a finished fibrous structure product.

The products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the paper towel product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

In one embodiment, the HFS value of a paper towel product may be from about 10 g/g to about 35 g/g, and/or from about 11 g/g to about 30 g/g, and/or from about 12 g/g to about 30 g/g and/or from about 14 g/g to about 28 g/g.

The products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the paper towel product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the paper towel product exhibits a total dry tensile strength of less than about 394 g/cm (1000 g/in) and/or less than about 335 g/cm (850 g/in).

In another example, the products of the present invention may exhibit a total dry tensile strength of greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The products of the present invention may comprise additives such as softening agents, temporary wet strength agents, permanent wet strength agents, bulk softening agents, lotions, silicones, and other types of additives suitable for inclusion in and/or on paper towel products.

“Ply” or “plies” as used herein means an individual finished fibrous structure optionally to be disposed in a substantially contiguous, face-to-face relationship with other plies, forming a multiple ply (“multi-ply”) paper product. It is also contemplated that a single-ply product can effectively form two “plies” or multiple “plies”, for example, by being folded on itself.

“Machine Direction” or “MD” as used herein means the direction parallel to the flow of the fibrous structure through the papermaking machine and/or product manufacturing equipment. In one example, once incorporated into a paper product, the MD of the fibrous structure may be the MD of the paper product.

“Cross Machine Direction” or “CD” as used herein means the direction perpendicular to the machine direction in the same plane of the fibrous structure. In one example, once incorporated into a paper product, the CD of the fibrous structure may be the CD of the paper product.

“Evidence” and/or “evidences” as used herein means that a paper product package, paper product and/or marketing article comprises indicia, textual and/or non-textual, that conveys information to a consumer about a paper product. In one example, the information about the paper product may be conveyed intuitively from non-textual indicia present on a paper product package, paper product and/or marketing article to a consumer.

“Intuitively” as used herein means that a consumer interprets the indicia based on the consumer's previous life experiences and/or knowledge.

“Indicia” as used herein means an indicator that conveys information to a consumer.

“Textual indicia” as used herein means text indicia, such as a word and/or phrase that conveys information to a consumer. In one example, a paper product is housed in a package comprising a textual indicia.

“Brand name” as used herein means a single source identifier, in other words, a brand name identifies a product and/or service as exclusively coming from a single commercial source (i.e., company). An example of a brand name is Charmin®, Bounty®, which are also trademarks. Brand names are nonlimiting examples of textual indicia. The paper products of the present invention may be marketed and/or packaged under a common brand name (i.e., the same brand name, such as Bounty®). In addition to the brand name, a product descriptor may also be associated with the paper products.

“Non-textual indicia” as used herein means non-text indicia that evidences information about a product to a consumer through a consumer's senses. In one example, non-textual indicia may evidence, even intuitively evidence, to a consumer through sight (visual indicia), through touch (texture indicia) and/or through smell (scent indicia), and combinations thereof.

Nonlimiting examples of non-textual indicia include pictures, graphs, drawings, representations such as product representations comparing two or more products, images, icons, colors, textures, patterns, such as emboss patterns and/or emboss pattern images, character representations, action representations, and mixture thereof.

As used herein, “basis weight” as used herein is the weight per unit area of a sample reported in lbs/3000 ft² or g/m². The basis weight is measured herein by the basis weight test method described in the Test Methods section herein.

As used herein, “texture” means any pattern present in the fibrous structure product. For example, a pattern may be imparted to the fibrous structure during the fibrous structure-wet making process, such as during a through-air-drying step. A pattern may also be imparted to the fibrous structure by embossing or brushing the finished fibrous structure during the converting process and/or by any other suitable process known in the art.

### Method for Demonstrating Surface Cleaning Performance (Surface Cleaning Test Method)

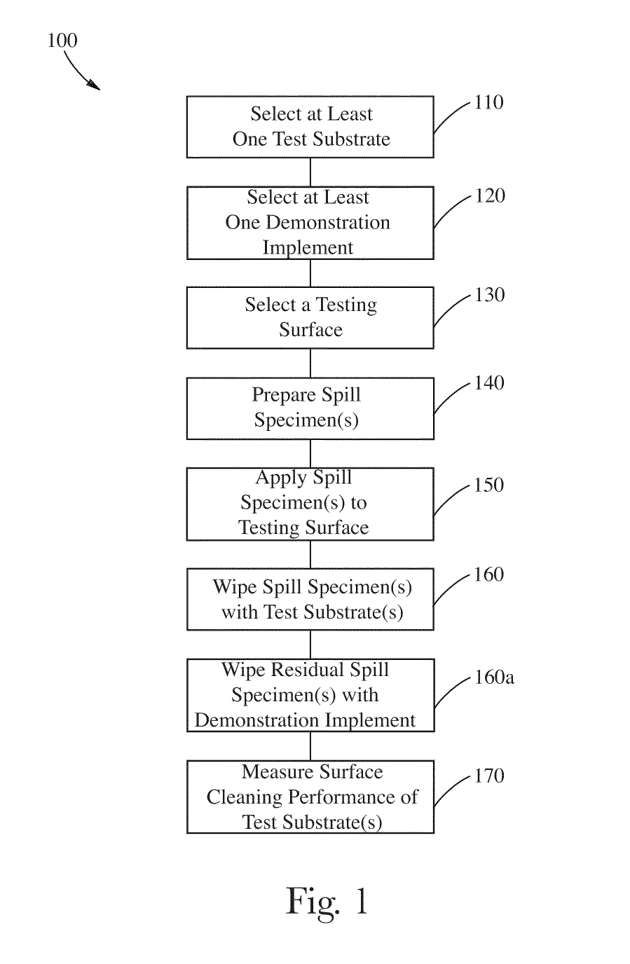

A schematic illustration of the steps involved in the surface cleaning test method of the present invention is shown in FIG. 1. The overall surface cleaning test method 100 is composed of a series of steps, some of which are sequential steps, selected to mimic how some consumers use paper products, e.g. paper towel products, in real life conditions to clean spills or messes on surfaces, for example hard surfaces, countertops, etc. The overall method 100 may be done in a comparative manner so that the consumer can evaluate how different products, within an array of branded products, or how products associated with different brands, will perform under similar use conditions.

The first step 110 of the process comprises selecting at least one test substrate. “Test substrate” as used herein means a cleaning implement used for cleaning surfaces found in a consumer's home such as a paper towel product, napkin, dishcloth, sponge, rag, cellulose substrate, fibrous structure product, article of clothing, etc.

For example the test substrates may comprise at least two paper towel products, comprising a first paper towel product and a second paper towel product, for a comparison such as a side-by-side comparison of these products. In another example the test substrates may comprise at least one paper towel product and at least one other type of cleaning implement such as a sponge or dishcloth, etc. In one embodiment the test substrate is pre-moistened with water prior to use, especially if a cleaning implement such as a cloth, dishrag, or sponge is used.

The second step 120 comprises selecting at least one demonstration implement for each test substrate. “Demonstration implement” as used herein means a cleaning implement used for cleaning surfaces found in a consumer's home such as a paper towel product, napkin, dishcloth, sponge, rag, cellulose substrate, fibrous structure product, as well as cloth materials for example an article of clothing such as a sock, shirt, gloves (e.g. white gloves made from paper, cotton or synthetic fabrics), etc. In one embodiment the demonstration implement is a white glove. In an embodiment the test substrates comprise a first test substrate and a second test substrate and the demonstration implement comprises a first demonstration implement to be used in association with the first test substrate and a second demonstration implement to be used in association with the second test substrate. In an embodiment the demonstration implements, to be used in association with more than one test substrate, are substantially identical. In an embodiment the purpose of the demonstration implement is to aid in visually demonstrating to the consumer or customer, the amount, relative amount, or quantity of the spill specimen that is not picked up by the test substrate after wiping (e.g. with one wipe cycle) the testing surface with the test substrate.

The third step 130 comprises selecting a testing surface. In an embodiment the testing surface comprises a solid surface countertop, hard surface flooring material such as vinyl, laminate, tile, synthetic, or hardwood flooring, glass, ceramic, porcelain, plastic, or other generally smooth surface of the type typically found in the kitchen area or other areas of a home, and combinations thereof. In an embodiment the testing surface is intended to mimic the surfaces that a consumer would want to clean in the kitchen, bath, or other areas of their home. In one embodiment the testing surface may be a 2 foot by 2 foot size sample of a Formica® surface, which comprises a high pressure laminated plastic sheet of synthetic resin employed as a heat resistant and chemical resistant surface for tabletop and countertops. In an embodiment the testing surface should be wiped clean prior to each use or between each application of spill specimen, for example with water or isopropal alcohol to strip off any residue of the spill specimen such as surfactants, etc.

The forth step 140 comprises preparing at least one spill specimen for each test substrate to be tested. In an embodiment, the spill specimen may be selected from the group comprising solid particulates, fluids, viscous fluids, and combinations thereof. In an embodiment the spill specimen may be selected from the group consisting of food, such as ketchup, spaghetti sauce, taco sauce, a mixture of liquid coffee plus coffee grounds, jam, jelly, honey, salad dressing, Kool-Aid®, sauces, juices, milk, pasta, etc., mud, water, pet messes, pet hair, and combinations thereof.

In an embodiment the spill specimens comprise substantially similar volume and/or composition. In an embodiment the spill specimens comprise from about 3% to about 95% and/or from about 5% to about 40%, moisture such as water. In one embodiment the spill specimen comprises at least some solid particulates in combination with liquids. In another embodiment the spill specimen may comprise solid particulates, in an embodiment from about 0.5% to about 60% and/or from about 0.5% to about 30%, and/or about 1% to about 3% by weight of the spill specimen, of solid particles. In an embodiment the volume of spill specimen is about 5 ml to about 20 ml, and/or from about 6 ml to about 10 ml. A 10 ml spill specimen size is a typical volume for a spill typically found in the kitchen area, as reported by some consumers. In an embodiment each spill specimen comprises from about 1 gram to about 25 grams and/or about 2 grams to about 20 grams, of solid particulates, fluids, viscous fluids, and combinations thereof.

A fifth step 150 comprises applying each spill specimen to the testing surface. In an embodiment each spill specimen is applied to a separate area of the testing surface. In an embodiment the spill specimens do not merge together but remain separate on the testing surface.

A sixth step 160 comprises wiping the spill specimen on the testing surface with a test substrate. In another embodiment this step comprises wiping each spill specimen on the testing surface with a separate test substrate. In an embodiment at least some of the spill specimen adheres to the test substrate. In an embodiment, thereafter, according to step 160a in FIG. 1, spill specimen that is left on the testing surface after wiping with the test substrate (e.g. residual spill specimen) is wiped again with a separate demonstration implement. A least some of the residual spill specimen adheres to the demonstration implement(s).

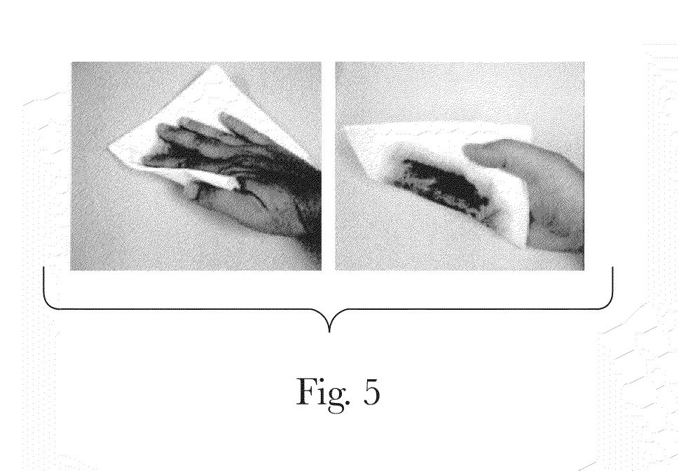

According to FIG. 5, showing a demonstration implement wiping step, in an embodiment, the demonstration wiping step comprises holding the demonstration implement at an angle relative to the testing surface while wiping the residual spill specimen. In an embodiment holding the demonstration implement at a greater angle relative to the testing surface will enable better viewing of the adherence of the residual spill specimen to the demonstration implement and the volume of the residual spill specimen that attaches to the demonstration implement.

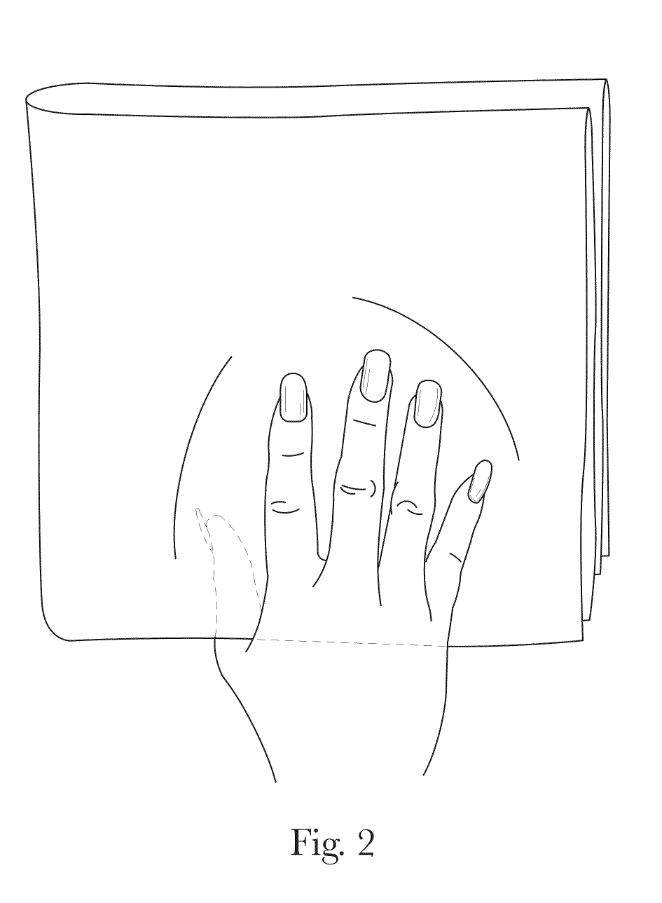

In an embodiment prior to wiping each spill specimen on the testing surface with the test substrates, if possible, the test substrate is prepared such as folding into a particular configuration. For example, since the first two sheets of a new roll of paper towel product and the last two sheets on new roll of paper towel product contain glue, one may avoid using these sheets. After at least one sheet is selected from the roll of paper towel product, then the sheet may be folded. FIG. 2 is a representation of how a sheet of a folded paper towel product may be held by a human hand for the wiping step, and illustrates an embodiment of how to prepare the paper towel product for use in the test method herein. For example, place the sheet on a table so that the side facing outwards on the roll faces downwards. Then fold the sheet in half, left to right, and fold the sheet again in half from top to bottom. As shown in FIG. 2, the analyst then grasps the folded towel in their right hand, between the thumb and the forefinger, by the edge away from the open-perforated, folded edge. The fingers may be spread over the folded sheet of the paper towel product, wherein the folded side of the sheet may contact the spill specimen, first, during the wiping step. This same preparation procedure may be used for preparation of the demonstration implement.

In an embodiment one of the spill specimens on the testing surface is wiped with the first test substrate such as a first paper towel product wherein at least some of the spill specimen adheres to the first test substrate. Then a second spill specimen on the testing surface is wiped with a second test substrate such as a cleaning implement such as a dishcloth, wherein at least some of the spill specimen adheres to the dishcloth. In another embodiment the test substrates comprise a first branded paper towel product and a second branded paper towel product having a different Brand name than the first paper towel product.

In an embodiment from about 50% to about 100% or from about 90% to about 100% of the spill specimen adheres to the test substrate after the wiping step. In an example the wiping step includes placing the test substrate such as a paper towel product flat on the testing surface. In an example the tester (human tester or machine tester such as a robotic wiping simulator) wipes the paper towel product for one wipe cycle or alternatively, back and forth (side to side or up and down motion) across the testing surface. For example, the wiping motion should move the test substrate across the testing surface a distance of from about 4 inches to about 30 inches or from about 20 inches to about 28 inches, for about 0.5 seconds to about 6 seconds to complete one wiping cycle. In one embodiment one wiping cycle comprises either one continuous wipe cycle or from about 2 to about 4 cycles (back and forth) moving the test substrate a distance from about 4 inches to about 30 inches each way. In one embodiment the wiping cycle is one continuous cycle with a distance of about 22 inches to about 26 inches. In an embodiment the entire hand may maintain contact with the test substrate and apply a constant pressure of about 0.15 to about 0.6 pounds per square inch (psi) or about 0.50 psi to about 0.5 psi. For example, a total of from about 1 to about 4 wipe cycles are completed for each test substrate being tested, taking a total of about 1 second to about 6 seconds to complete per wiping cycle. The wiping step using the test substrate may be repeated (e.g. 5 times) to provide a more accurate average measure of spill specimen clean up.

In an embodiment a separate spill specimen is used for each test substrate. In an embodiment the wiping step for the first test substrate and the second test substrate occurs simultaneously or is synchronized in a side by side comparison.

The average pressure applied by consumers when performing a cleanup on a solid surface is from about 0.2 psi to about 0.4 psi. This pressure may be determined using a Force Sensing Array, Mat Model 1010, produced by Vista Medical, Winnipeg, MB, Canada. The pad is a relatively large pad (40.64 cm×40.64 cm) (16″×16″) with an array of 256 (2.54 cm×2.54 cm) (1″×1″) silicone resistors that directly measure the pressure over the entire wipe area in 0.1 second intervals. Calibration is accomplished using a pressure bladder, providing uniform pressure across the array. Average pressures are summarized in Table 1 below.

TABLE 1
Average pressure used by consumers to clean up spills and marks

| Description of spill and instructions | Base size | Average Pressure (psi) |
|---|---|---|
| 15 ml water, vinyl floor | 19 | 0.3 psi |
| Instructions; wipe spill | | |
| 5 ml jam, vinyl floor | 19 | 0.4 psi |
| Instructions; wipe spill | | |

In an embodiment, after wiping each spill specimen on the testing surface with a test substrate each residual spill specimen left on the testing surface is wiped again with a demonstration implement wherein at least some of the residual spill specimen adheres to the demonstration implement. The wiping motion and wiping cycle, as indicated herein, may also apply to the wiping step using the demonstration implement.

In one embodiment the demonstration implement is a white colored cloth, such as a white glove, made from a fabric or other paper material, white paper towel, white filter paper, and/or white dishcloth. Due to potential for evaporation of the spill specimen, this second wiping step, in an embodiment, is performed quickly after the first wiping step, for example within about 5 seconds to about 60 seconds or from about 10 seconds to about 30 seconds after the first wiping step with the test substrates.

In an embodiment the demonstration method of the present invention may be aided by the selection of a testing surface, test substrates, demonstration implements, and/or spill specimens, that comprise visual contrast. As used herein “visual contrast” means density, shading, or color variation or contrast perceived by the human eye. For example, the testing surface, demonstration implement, and/or the spill specimen may be different colors, different color shades, comprise different light reflective properties, comprise different florescent properties, etc., and combinations thereof. In an example, the demonstration implement or the testing surface maybe white and the spill specimen may be orange or red. The demonstration implement or the testing surface may be black and the spill specimen may comprise florescent properties, etc.

A seventh step 170 comprises demonstrating the surface cleaning performance of the test substrate(s). In an embodiment demonstrating the surface cleaning performance includes measuring the surface cleaning performance differences between different test substrate(s). In an embodiment the cleaning performance of a test substrate or cleaning performance differences between different test substrates is evidenced, for example, is visible on the demonstration implement. In one embodiment the results are a quantification of how much cleaner that the testing surface becomes once the test substrates have been used to wipe the spill specimen.

One may demonstrate or measure the performance differences or results by determining the amount of the spill specimen that is picked up by the test substrate. For example, the spill specimen may be weighed prior to placing on the testing surface. The dry test substrates are then weighed. The spill specimen on the testing surface is wiped with the test substrate. Thereafter the test substrates are reweighed. The amount of the spill specimen picked up by each test substrate may then be determined by subtracting the weight of the spill specimen from the weigh of the testing substrate after wiping the spill specimen. A four place analytical balance that is calibrated, may be used to determine these weights, for example, analytical balance, Model Number XS204, from Mettler Toledo, (accuracy minimum graduation of 0.0001 g., max load of 220 g) may be used to determine the weights of the spill specimens, test substrates, etc.

In addition, demonstrating or measuring the surface cleaning performance may be accomplished by determining the amount of the spill specimen that is left behind on the testing surface and picked up by the demonstration implement. For example, the spill specimen may be weighed prior to placing on the testing surface. The dry test substrates and demonstration implements are then weighed. The spill specimen on the testing surface is wiped with the test substrate. Thereafter the test substrates are reweighed. The amount of the spill specimen picked up by each test substrate may then be determined by subtracting the weight of the spill specimen from the weigh of the testing substrate after wiping the spill specimen. Thereafter, in an embodiment, the spill specimen left on the testing surface (e.g. residual spill specimen) is wiped with a separate demonstration implement wherein any residual spill specimen adheres to the demonstration implement(s).

The results collected in this step could be automated utilizing common and commercially available image analysis equipment and software.

Table 2 summarizes the results of a comparison of the leading paper towel product and various store bargain brands found on the marketplace.

TABLE 2
Demonstration results

| | Test Substrate | | | | | | | |
|---|---|---|---|---|---|---|---|---|
| | 1 -11″ × 11″ | | 1- 11″ × 11″ | | 1- 11″ × 11″ | | | |
| | sheet of Bounty | | sheet of Store | | sheet of Store | | | |
| | paper towel | | Brand Paper Towel | | Brand Paper Towel | | Dish rag | |
| Testing Surface | | | | | | | | |
| Demonstration | | | | | | | | |
| Implement | | | | | | | | |
| Spill Specimen | | | | | | | | |
| Avg Grams Coffee | 10.02 | g | 10.02 | g | 10.02 | g | 10.02 | g |
| (liquid) | | | | | | | | |
| Avg Grams Coffee | 0.2 | g | 0.2 | g | 0.2 | g | 0.2 | g |
| grounds | | | | | | | | |
| Avg Grams total | 10.2 | g | 10.2 | g | 10.2 | g | 10.2 | g |
| spill | | | | | | | | |
| Avg Grams pick up | 10.1094 | g | 9.9074 | g | 9.9071 | g | 9.6909 | g |
| (of spill specimen) | | | | | | | | |
| Avg % pick up of | 99.27% | | 97.17% | | 97.09% | | 95.23% | |
| spill specimen | | | | | | | | |
| Avg Calculated | 0.0743 | g | 0.2887 | g | 0.2964 | g | 0.4858 | g |
| Grams residual (left | | | | | | | | |
| on surface) | | | | | | | | |

| | | | | |
|---|---|---|---|---|
| Avg Calculated % | 0.730% | 2.831% | 2.905% | 4.769% |
| residual (left on | | | | |
| surface) | | | | |

10 replicates are performed for each test substrate.

In another example, the surface cleaning performance results may be obtained by determining the amount of the spill specimen that is left on the testing surface after wiping with the test substrates.

An optional eighth step is presenting the results to consumers. Nonlimiting examples of ways that the results may be presented to consumers include visually, numerically and/or graphically.

Visually presenting the results may include conducting a simulated, in-use performance of the test method for the paper product in the presence of one or more consumers and then showing the results; showing the results to a consumer in person; and/or representing the results in an image, such as a photograph or video, to the consumer.

Visually presenting the results may include showing the consumer the demonstration implement(s) (e.g. which is a visual representation) after wiping the residual spill specimen to show the amount of spill specimen remaining on the testing surface after the spill specimens are wiped with each test substrate. In an embodiment by providing this visual representation to consumers, the consumers are able to better understand the cleaning performance characteristics of the test substrates.

Numerically presenting the results to consumers may include: providing the volume and/or weight of the spill specimen that is picked up by each test substrate or providing the volume and/or weight of the spill specimen that is left on the testing surface after wiping the testing surface with the test substrates, to the consumers. Numerically presenting the results to consumers may also include showing the consumers an image or icon that indicates that the testing surface is 3 times, 4 times, and/or 5 times, cleaner (e.g. from greater than about 1 to about 50 times cleaner, or about 2 to about 20 times cleaner) than prior to use of the test substrate or from greater than about 1 to about 20 times cleaner than another test substrate when 2 or more test substrate are tested together. Numerically presenting the results to consumers may also include an image or icon that indicates that the test substrate removed a certain percentage of spill specimen on the testing surface or only left a certain percentage of the spill specimen on the test surface.

Graphically presenting the results to consumers may include providing a graph that evidences the results.

The results may be presented to the consumers in one or more of the following ways: airing a television commercial comprising the results; placing the results on the Internet; distributing a print advertisement comprising the results; distributing or presenting the results on paper towel product packages, presenting the results on the paper towel product (for example by printing the results on the paper towel product and/or by embossing the results on the paper towel product, displaying the results on an in-store display or on in store advertising materials; and/or displaying the results on a billboard.

The results may be obtained from the surface cleaning test method described herein.

### Paper Product Package

In an embodiment the present invention also relates to a paper product package comprising a paper product and a packaging comprising a textual or non-textual indicia that evidences to a consumer that the paper towel product exhibits, via the method herein, surface cleaning performance or surface cleaning performance differences from another test substrate.

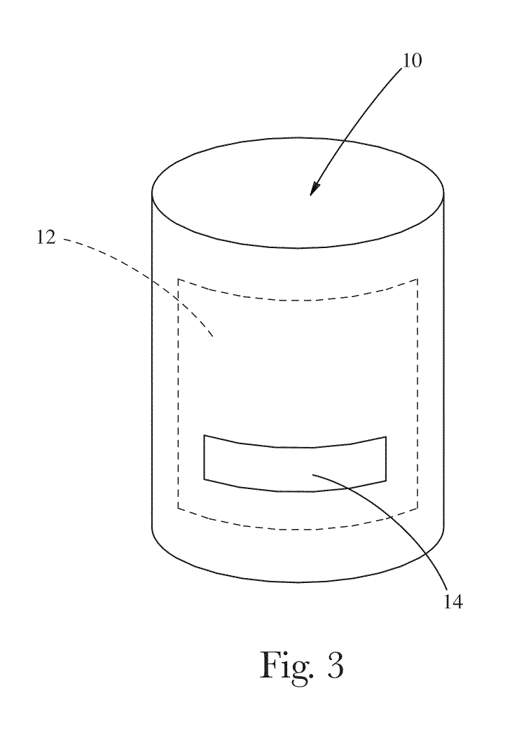

As shown in FIG. 3, a paper product package 10 housing a paper towel product (that is the test substrate) 12 tested according the method of the present invention, wherein the package 10 may comprise an indicia 14, that may be textual or non-textual indicia. The indicia 14 evidences to a consumer, that test substrate (such as a paper towel product) 12 exhibits a surface cleaning performance or exhibits a surface cleaning performance that is different from another test substrate. The method of the present invention may be recorded via photography or film or through the use of animation techniques. The indicia described herein may be an individual image from this recording or an individual frame from this recording.

In an example, the paper towel product package 10 may comprise indicia 14 selected from the group consisting of: pictures, graphs, drawings, representations, images, icons and combinations thereof.

### Marketing Article

In an embodiment the present invention also relates to a marketing article comprising a textual or non-textual indicia that evidences to a consumer that a paper product exhibits, via the method herein, surface cleaning performance or surface cleaning performance differences from another test substrate.

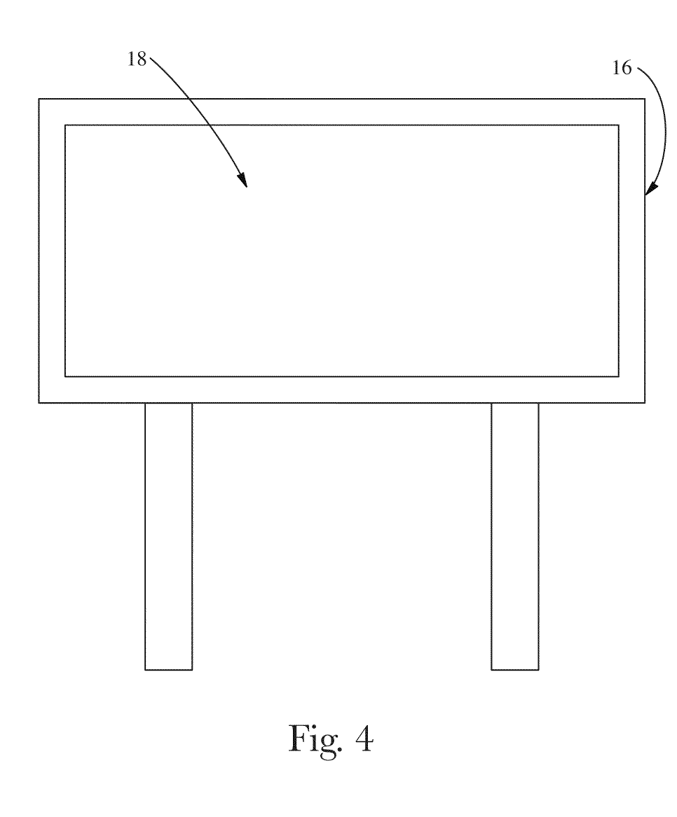

As shown in FIG. 4, a marketing article, for example a billboard, 16 may comprise indicia 18, that may be textual or nontextual indicia, that evidences to a consumer that a test substrate, such as a paper towel product, exhibits surface cleaning performance or surface cleaning performance differences from another test substrate. In an embodiment the indicia 14 and the indicia 18 are substantially similar and the marketing article 16 is utilized in association the package 10.

The marketing article 16 may comprise indicia 18 selected from the group consisting of: pictures, graphs, drawings, representations, images, icons and combinations thereof.

The marketing article 16 may be selected from the group consisting of: print advertisements, in-store display advertisements, billboard advertisements, television advertisements, Internet advertisements and combinations thereof.

### Test Methods

Unless otherwise indicated, all tests described herein including those described under the Definitions section and the following test methods are conducted on test substrates, samples, fibrous structure samples and/or paper towel product samples and/or handsheets that have been conditioned in a conditioned room at a temperature of 73° F.±4° F. (about 23° C.±2.2° C.) and a relative humidity of 50%±10% for 4 hours prior to the test. Further, all tests may be conducted in such conditioned room.

### Basis Weight Method:

Basis weight is measured by preparing one or more samples of a certain area (m²) and weighing the sample(s) of a fibrous structure according to the present invention and/or a paper towel product comprising such fibrous structure on a top loading balance with a minimum resolution of 0.01 g. The balance is protected from air drafts and other disturbances using a draft shield. Weights are recorded when the readings on the balance become constant. The average weight (g) and the average area of the samples (m²) are calculated. The basis weight (g/m²) is calculated by dividing the average weight (g) by the average area of the samples (m²).

### HFS (Horizontal Full Sheet)

The Horizontal Full Sheet (HFS) test method determines the amount of distilled water absorbed and retained by the paper towel product herein or test substrate. This method is performed by first weighing a sample of the paper to be tested (referred to herein as the “Dry Weight of the paper”), then thoroughly wetting the paper, draining the wetted paper in a horizontal position and then reweighing (referred to herein as “Wet Weight of the paper”). The absorptive capacity of the paper is then computed as the amount of water retained in units of grams of water absorbed by the paper.

The apparatus for determining the HFS capacity of paper comprises the following: An electronic balance with a sensitivity of at least ±0.01 grams and a minimum capacity of 1200 grams. The balance should be positioned on a balance table and slab to minimize the vibration effects of floor/benchtop weighing. The balance should also have a balance pan to be able to handle the size of the paper tested. The balance pan can be made out of a variety of materials. Plexiglas is a common material used.

A sample support rack and sample support cover is also required. Both the rack and cover are comprised of a lightweight metal frame, strung with 0.012 in. (0.305 cm) diameter monofilament so as to form a grid of 0.5 inch squares (1.27 cm2). The size of the support rack and cover is such that the sample size can be conveniently placed between the two.

The HFS test is performed in an environment maintained at 23±1° C. and 50±2% relative humidity. A water reservoir or tub is filled with distilled water at 23±1° C. to a depth of 3 inches (7.6 cm).

The paper to be tested is carefully weighed on the balance to the nearest 0.01 grams. The dry weight of the sample is reported to the nearest 0.01 grams. The empty sample support rack is placed on the balance with the special balance pan. The balance is then zeroed (tared). The sample is carefully placed on the sample support rack. The support rack cover is placed on top of the support rack. The sample (now sandwiched between the rack and cover) is submerged in the water reservoir. After the sample has been submerged for 60 seconds, the sample support rack and cover are gently raised out of the reservoir.

The sample, support rack and cover are allowed to drain horizontally for 120±5 seconds, taking care not to excessively shake or vibrate the sample. Next, the rack cover is carefully removed and the wet sample and the support rack are weighed on the previously tared balance. The weight is recorded to the nearest 0.01 g. This is the wet weight of the sample.

The grams of water per paper sample absorptive capacity of the sample (or HFS value) is defined as (Wet Weight of the paper—Dry Weight of the paper).

### Dry Tensile Strength Test Method:

One (1) inch by five (5) inch (2.5 cm×12.7 cm) strips of fibrous structure and/or paper towel product are provided. The strip is placed on an electronic tensile tester Model 1122 commercially available from Instron Corp., Canton, Mass. in a conditioned room at a temperature of 73° F.±4° F. (about 28° C.±2.2° C.) and a relative humidity of 50%±10%. The crosshead speed of the tensile tester is 2.0 inches per minute (about 5.1 cm/minute) and the gauge length is 4.0 inches (about 10.2 cm). The Dry Tensile Strength can be measured in any direction by this method. The “Total Dry Tensile Strength” or “TDT” is the special case determined by the arithmetic total of MD and CD tensile strengths of the strips.

The sample is tested in two orientations, referred to here as MD (machine direction, i.e., in the same direction as the continuously wound reel and forming fabric) and CD (cross-machine direction, i.e., 90° from MD). The MD and CD wet tensile strengths are determined using the above equipment and the Total Wet Tensile is determined by taking the sum of these two values.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for demonstrating the surface cleaning performance of a tissue towel paper product comprising the steps of:
selecting at least one test substrate comprising at least one tissue towel paper product;
selecting at least one demonstration implement for at least one test substrate;
selecting a testing surface;
preparing at least one spill specimen for at least one test substrate;
applying each spill specimen to the testing surface;
wiping the spill specimen on the testing surface with the test substrate wherein at least some of the spill specimen adheres to the test substrate and some of the spill specimen remains on the testing surface as residual spill specimen, and thereafter, wiping the residual spill specimen left on the testing surface with a demonstration implement wherein at least some of the residual spill specimen adheres to the demonstration implement;
demonstrating the surface cleaning performance of the test substrate.

2. The method according to claim 1 wherein the test substrates comprise at least one paper towel product and at least one cleaning implement.

3. The method according to claim 1 comprising the additional step of presenting the results to the consumer.

4. The method according to claim 2 wherein demonstrating the surface cleaning performance comprises measuring the surface cleaning performance differences between the paper towel product and the cleaning implement.

5. The method according to claim 2 wherein demonstrating the surface cleaning performance comprises the weight differences of the spill specimen that is adhered to each test substrate.

6. The method according to claim 2 wherein demonstrating the surface cleaning performance comprises the weight or volume differences of the spill specimen that is adhered to each demonstration implement.

7. The method according to claim 1 wherein each of the spill specimens comprise substantially identical compositions.

8. The method according to claim 1 wherein each of the spill specimens comprise substantially identical volume.

9. The method according to claim 1 wherein the testing surface comprises a solid surface countertop, flooring material, glass, ceramic, porcelain, tile, plastic, and combinations thereof.

10. The method according to claim 3 wherein the step of presenting the results to the consumer comprises airing a television commercial.

11. The method according to claim 3 wherein the step of presenting the results to the consumer comprises placing the results on the Internet.

12. The method according to claim 3 wherein the step of presenting the results to the consumer comprises distributing a print advertisement.

13. The method according to claim 3 wherein the step of presenting the results to the consumer comprises distributing the results as an indicia on paper towel product package.

14. The method according to claim 3 wherein the step of presenting the results to the consumer comprises displaying the results on an in-store display.

15. The method according to claim 3 wherein the step of presenting the results to the consumer comprises displaying the results on a billboard.

16. The method according to claim 3 wherein the step of presenting the results to the consumer comprises visually, numerically and/or graphically presenting the results to the consumer.

17. The method according to claim 1 wherein the wiping steps comprises the use of a robotic simulated, in-use wiping process.

18. A paper product package comprising a paper towel product and a packaging comprising a textual or non-textual indicia that evidences to a consumer that the paper towel product exhibits, via the method of claim 1, surface cleaning performance or surface cleaning performance differences from another test substrate.

19. The paper towel product package according to claim 18 wherein the indicia is selected from the group consisting of: pictures, graphs, drawings, representations, images, icons and mixtures thereof and the indicia evidences, to a consumer through sight (visual indicia), through touch (texture indicia), through smell (scent indicia), and combinations thereof.

20. A marketing article comprising a textual or non-textual indicia that evidences to a consumer that a tissue towel product exhibits, via the method of claim 1, surface cleaning performance or surface cleaning performance differences from another test substrate.

21. The marketing article according to claim 20 wherein the indicia is selected from the group consisting of: pictures, graphs, drawings, representations, images, icons and combinations thereof.

22. The marketing article according to claim 20 wherein the marketing article is selected from the group consisting of: print advertisements, in-store display advertisements, billboard advertisements, television advertisements, Internet advertisements and combinations thereof.
